(19) United States
(12) Patent Application Publication
(10) Pub. No.: US 2019/0221152 A1
(43) Pub. Date: Jul. 18, 2019

(54) DISPLAY DEVICE

(71) Applicant: Samsung Display Co., Ltd., Yongin-si (KR)

(72) Inventor: Yong-Han PARK, Hwaseong-si (KR)

(21) Appl. No.: 16/048,346

(22) Filed: Jul. 30, 2018

(30) Foreign Application Priority Data
Jan. 17, 2018 (KR) 10-2018-0006030

(51) Int. Cl. G09G 3/20

(52) U.S. Cl. CPC G09G 3/2092; G09G 2380/02; G09G 2300/0426; G09G 2300/02

(57) ABSTRACT

A display device includes a display panel and a driving circuit portion. The display panel includes a first display portion, a second display portion, and a connecting portion. The driving circuit portion is disposed on the connecting portion. The connecting portion is connected to the first display portion and the second display portion, and is disposed between the first display portion and the second display portion. The first display portion includes first pixels and first data lines electrically connected to the first pixels. The second display portion includes second pixels and second data lines electrically connected to the second pixels. The driving circuit portion is electrically connected to the first data lines and the second data lines.

### CROSS-REFERENCE TO RELATED APPLICATION

This application claims priority from and the benefit of Korean Patent Application No. 10-2018-0006030, filed Jan. 17, 2018, which is hereby incorporated by reference for all purposes as if fully set forth herein.

### BACKGROUND

### Field

Exemplary embodiments generally relate to display devices.

### Discussion

A display device, such as a liquid crystal display (LCD), an organic light emitting diode (OLED) display, etc., typically includes a display panel including a plurality of pixels that can display an image. Each pixel usually includes a pixel electrode for receiving a data signal, and the pixel electrode is connected to at least one transistor to receive the data signal. Some display devices have a plurality of display areas capable of displaying images in different directions.

The above information disclosed in this section is only for understanding the background of the inventive concepts, and, therefore, may contain information that does not form prior art.

### SUMMARY

Some exemplary embodiments provide a display device including a plurality of display areas capable of displaying images in different directions from each other, and that may have a simple structure and may reduce a manufacturing cost thereof.

Additional aspects will be set forth in the detailed description which follows, and, in part, will be apparent from the disclosure, or may be learned by practice of the inventive concepts.

According to some exemplary embodiments, a display device includes a display panel and a driving circuit portion. The display panel includes a first display portion, a second display portion, and a connecting portion. The driving circuit portion is disposed on the connecting portion. The connecting portion is connected to the first display portion and the second display portion, and is disposed between the first display portion and the second display portion. The first display portion includes first pixels and first data lines electrically connected to the first pixels. The second display portion includes second pixels and second data lines electrically connected to the second pixels. The driving circuit portion is electrically connected to the first data lines and the second data lines.

In some exemplary embodiments, the first display portion and the second display portion may be configured to respectively display images in different directions from each other.

In some exemplary embodiments, the display panel includes a flexible substrate; the first display portion, the second display portion, and the connecting portion may be disposed on the flexible substrate; and the display panel may be bent or bendable at at least a portion among at least one of a first boundary between the connecting portion and the first display portion, a second boundary between the connecting portion and the second display portion, and the connecting portion.

In some exemplary embodiments, the display device may further include at least one insulating layer disposed on the flexible substrate. The at least one insulating layer may include a portion disposed on the first display portion and the second display portion. The at least one insulating layer may be removed at the connecting portion.

In some exemplary embodiments, the driving circuit portion may include a first output portion electrically connected to the first data lines, a second output portion electrically connected to the second data lines, and an input portion. The first output portion and the second output portion may be disposed respectively adjacent to two edges of the driving circuit portion, the two edges opposing each other.

In some exemplary embodiments, the connecting portion may include signal lines electrically connected to the input portion, and the display device may further include a circuit film electrically connected to the signal lines.

In some exemplary embodiments, the circuit film may be bent to overlap the connecting portion.

In some exemplary embodiments, the connecting portion may include a first edge extending from the first display portion to the second display portion, and the circuit film may be bent at a portion adjacent to the first edge.

In some exemplary embodiments, the connecting portion may include a cutout, the cutout including a portion adjacent to an end portion of the signal lines. The circuit film may be connected to a first portion of the connecting portion that is divided by the cutout. The first portion may be bent to overlap a remaining portion of the connecting portion.

In some exemplary embodiments, the cutout may include a second portion disposed between a portion at which the second data lines are disposed and a portion at which the signal lines are disposed.

In some exemplary embodiments, a direction in which the connecting portion and the first display portion or the second display portion are arranged may be the same as a direction in which the first portion and the circuit film are arranged.

In some exemplary embodiments, a width in a first direction of the connecting portion may be smaller than a width in the first direction of at least one among the first display portion and the second display portion.

According to some exemplary embodiments, a display device includes a display panel, a driving circuit portion, a first signal line, and a second signal line. The display panel includes a first display portion, a second display portion, and a connecting portion. The driving circuit portion is disposed on the connecting portion. The first signal line includes a portion disposed on the first display portion. The second signal line includes a portion disposed on the second display portion. The connecting portion is connected to the first display portion and the second display portion, and is disposed between the first display portion and the second display portion. The driving circuit portion includes a first output portion connected to the first signal line, and a second output portion connected to the second signal line. The first output portion and the second output portion are disposed respectively adjacent to two edges of the driving circuit portion, the two edges opposing each other.

In some exemplary embodiments, the first display portion and the second display portion may respectively display image in different directions from each other.

In some exemplary embodiments, the display panel may further include a flexible substrate. The first display portion, the second display portion, and the connecting portion may be disposed on the flexible substrate. The display panel may be bent or bendable at at least a portion among at least one of a first boundary between the connecting portion and the first display portion, a second boundary between the connecting portion and the second display portion, and the connecting portion.

In some exemplary embodiments, the driving circuit portion may include an input portion separate from the first output portion and the second output portion, the connecting portion may include a third signal line electrically connected to the input portion, the display device may further include a circuit film electrically connected to the third signal line, and the circuit film may include a portion overlapping the connecting portion.

In some exemplary embodiments, the connecting portion may include a cutout, the cutout including a portion adjacent to an end portion of the third signal line. The circuit film may be connected to a first portion of the connecting portion that is divided by the cutout. The first portion may be bent to overlap a remaining portion of the connecting portion.

According to some exemplary embodiments, a display device includes a display panel, a driving circuit portion, a first data line, and a second data line. The display panel includes a first display portion, a second display portion, and a connecting portion. The driving circuit portion is disposed on the connecting portion. The first data line includes a portion disposed on the first display portion. The second data line includes a portion disposed on the second display portion. The connecting portion is connected to the first display portion and the second display portion, and is disposed between the first display portion and the second display portion. The display panel is bent or bendable at at least a portion among at least one of a first boundary between the first display portion and the connecting portion, a second boundary between the connecting portion and the second display portion, and the connecting portion. The first data line substantially extends in a first direction in a display area of the first display portion. At least one among the first boundary and the second boundary extends in a second direction different from the first direction.

In some exemplary embodiments, the driving circuit portion may be electrically connected to the first data line and the second data line.

In some exemplary embodiments, the first display portion and the second display portion may respectively display images in different directions from each other.

According to various exemplary embodiments, it is possible to provide a display device that has a plurality of display areas capable of displaying images in different directions from each other, and that may have a simple structure and may reduce a manufacturing cost thereof.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 illustrates a plan layout view of a display panel of a display device in an unbent state according to some exemplary embodiments.

FIGS. 2 and 3 schematically illustrate respective side views of bent states of a display panel according to various exemplary embodiments.

FIG. 4 illustrates disposition of bumps included in a driving circuit portion disposed at a connecting portion of a display device according to some exemplary embodiments.

FIG. 5 schematically illustrates a plan layout view of a connecting portion of a display device according to some exemplary embodiments.

FIG. 6 illustrates a plan layout view of a display panel of a display device in an unbent state according to some exemplary embodiments.

FIG. 7 schematically illustrates a plan layout view of a connecting portion of a display device according to some exemplary embodiments.

FIG. 8 illustrates a cross-sectional view of a pixel of a display panel according to some exemplary embodiments.

FIG. 9 illustrates a cross-sectional view of the display panel of FIG. 1 taken along sectional line Ia-Ib according to some exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some exemplary embodiments. Therefore, unless otherwise specified, the features, components, modules, layers, films, panels, regions, aspects, etc. (hereinafter individually or collectively referred to as an “element” or “elements”), of the various illustrations may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element is referred to as being “on,” “connected to,” or “coupled to” another element, it may be directly on, connected to, or coupled to the other element or intervening elements may be present. When, however, an element is referred to as being “directly on,” “directly connected to,” or “directly coupled to” another element, there are no intervening elements present. Other terms and/or phrases used to describe a relationship between elements should be interpreted in a like fashion, e.g., “between” versus “directly between,” “adjacent” versus “directly adjacent,” “on” versus “directly on,” etc. Further, the term “connected” may refer to physical, electrical, and/or fluid connection. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

For the purposes of this disclosure, the term or phrase “in a plan view” means that a surface parallel to two directions (e.g., an X direction and a Y direction) crossing each other is viewed from a direction (e.g., a Z direction) perpendicular to the two directions. The term or phrase “in a plan view” may also be referred to as “in an XY plan” or “in an XY plan view.” In addition, for the purposes of this disclosure, the term or phrase “in a cross-sectional view” means that a surface cut in a direction perpendicular (e.g., a Z direction) to a surface parallel to two directions (e.g., an X direction and a Y direction) is viewed. Further, the overlapping of two constituent elements means that the two constituent elements overlap one another in a Z direction (e.g., a direction perpendicular to an upper surface of a substrate), unless stated otherwise.

Although the terms “first,” “second,” etc. may be used herein to describe various elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one element's relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. In this manner, regions illustrated in the drawings may be schematic in nature and shapes of these regions may not reflect the actual shapes of regions of a device, and, as such, are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the inventive concepts. Further, the blocks, units, and/or modules of some exemplary embodiments may be physically combined into more complex blocks, units, and/or modules without departing from the inventive concepts.

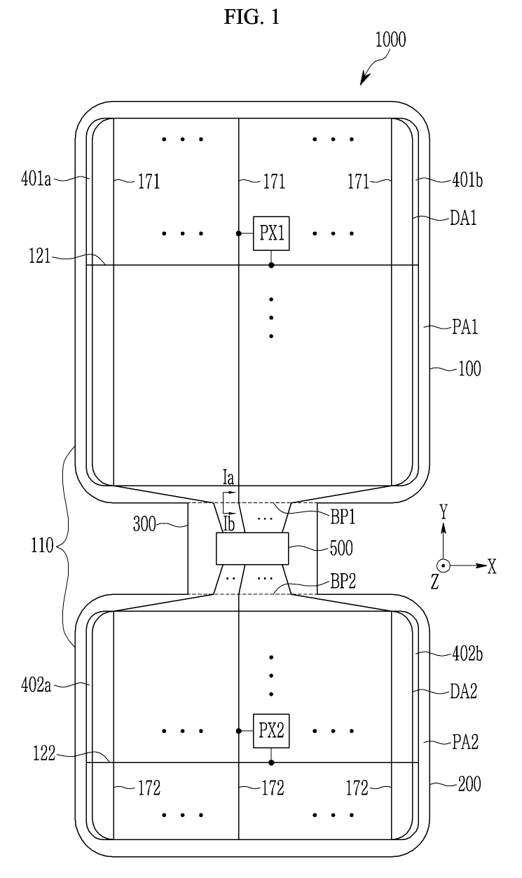

A display device according to some exemplary embodiments will now be described with reference to FIGS. 1 to 5.

FIG. 1 illustrates a plan layout view of a display panel of a display device in an unbent state according to some exemplary embodiments.

Referring to FIG. 1, the display device includes a display panel 1000 and a driving circuit portion 500.

The display panel 1000 includes a plurality of display portions (e.g., display portions 100 and 200), and at least one connecting portion 300 for connecting adjacent display portions, such as display portions 100 and 200. The plurality of display portions include a first display portion 100 and a second display portion 200. For descriptive convenience, the plurality of display portions will be referred to as “the plurality of display portions 100 and 200,” but it is to be appreciated that the display panel 1000 may include more than two display portions.

The plurality of display portions 100 and 200 and the connecting portion 300 may be disposed in (or on) one substrate 110. In other words, the substrate 110 may be a single substrate including the plurality of display portions 100 and 200 and the connecting portion 300.

The substrate 110 may include an insulating material and may be flexible. For example, the substrate 110 may be made of one or more plastic (or polymer) materials (such as at least one of polyethylene terephthalate (PET), polyethylene naphthalate (PEN), polycarbonate (PC), polyarylate (PAR), polyetherimide (PEI), polyethersulphone (PES), and polyimide (PI)), a metal thin film, or a glass thin film. The substrate 110 may be a film type.

The first display portion 100 includes a first display area DA1 that is an area capable of displaying an image and a first peripheral area PA1 that is an outer area of the first display area DA1, and the second display portion 200 includes a second display area DA2 that is an area capable of displaying an image and a second peripheral area PA2 that is an outer area of the second display area DA2. As shown in FIG. 1, before the display panel 1000 is bent, an image may be displayed on respective surfaces of the first and second display areas DA1 and DA2 that are parallel to an X direction and a Y direction. Each of the first and second display areas DA1 and DA2 may correspond to each display surface of the display device.

Each of the first display portion 100 and the second display portion 200 may independently display an image. That is, the first display portion 100 and the second display portion 200 may be independently driven.

The first display area DA1 may include a plurality of first pixels PX1 and a plurality of first signal lines 121 and 171, and the second display area DA2 may include a plurality of second pixels PX2 and a plurality of second signal lines 122 and 172. Each of the first and second pixels PX1 and PX2 may include at least one switching element and a pixel electrode connected to the switching element. The switching element may be a three terminal element, such as a transistor, integrated in (or otherwise as part of) the display panel 1000. The first and second signal lines 121, 122, 171, and 172 may include a plurality of first and second gate lines 121 and 122 that are connected to control terminals (or gates) of the switching elements of the first and second pixels PX1 and PX2 to transmit a gate signal, and a plurality of first and second data lines 171 and 172 for transmitting a data signal to the first and second pixels PX1 and PX2. The switching elements of the first and second pixels PX1 and PX2 are turned on or turned off according to the gate signals to selectively transmit the data signals transmitted by the first and second data lines 171 and 172 to the pixel electrodes. Each of the first and second gate lines 121 and 122 substantially extends in the X direction in each of the first and second display areas DA1 and DA2, and each of the first and second data lines 171 and 172 may cross each of the plurality of first and second gate lines 121 and 122 in each of the first and second display areas DA1 and DA2 and may extend in the Y direction.

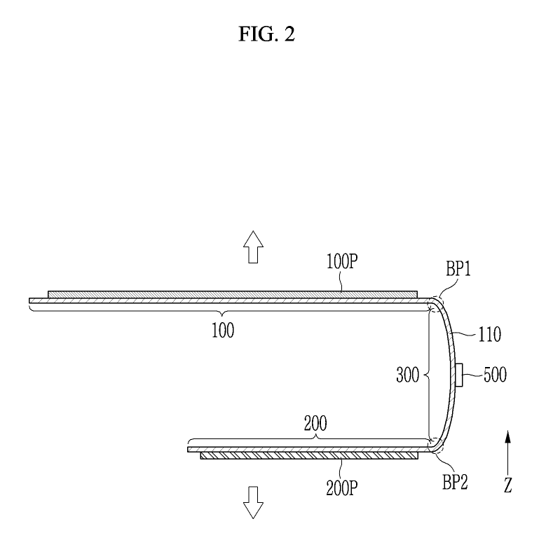

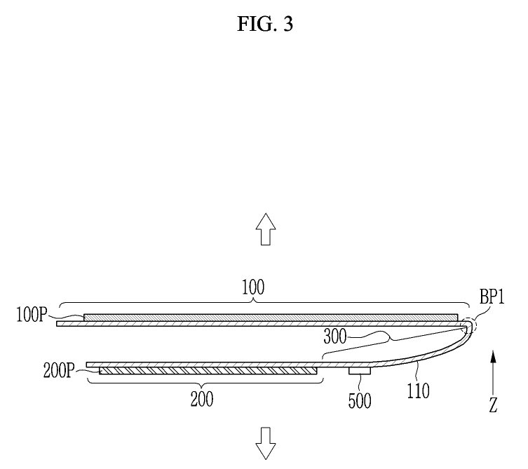

FIGS. 2 and 3 schematically illustrate respective side views of bent states of a display panel according to various exemplary embodiments.

Referring to FIG. 2 and FIG. 3, on the substrate 110, a first display element portion 100P including the first pixels PX1 may be disposed in an area corresponding to the first display area DA1 of the first display portion 100, and a second display element portion 200P including the second pixels PX2 may be disposed in an area corresponding to the second display area DA2 of the second display portion 200.

Referring to FIG. 1, first and second gate drivers 401a and 401b may be disposed in the first peripheral area PA1 of the first display portion 100, and third and fourth gate drivers 402a and 402b may be disposed in the second peripheral area PA2 of the second display portion 200. In the first and second display portions 100 and 200, the first, second, third, and fourth gate drivers 401a, 401b, 402a, and 402b may be disposed in the left and right peripheral areas PA1 and PA2 based on the respective first and second display areas DA1 and DA2. The first, second, third, and fourth gate drivers 401a, 401b, 402a, and 402b may be connected to the first and second gate lines 121 and 122 to transmit gate signals. The first, second, third, and fourth gate drivers 401a, 401b, 402a, and 402b may be formed on the substrate 110 together with the plurality of signal lines 121, 122, 171, and 172 and the switching elements that are disposed in the respective first and second display areas DA1 and DA2. In the first and second display portions 100 and 200, the first and second gate drivers 401a and 401b or the third and fourth gate drivers 402a and 402b may be omitted.

An XY planar area of the first display portion 100 and an XY planar area of the second display portion 200 may be different or the same. Similarly, an XY planar area of the first display area DA1 of the first display portion 100 and an XY planar area of the second display area DA2 of the second display portion 200 may be different or the same. FIG. 1 illustrates an example in which the XY planar areas of the first display portion 100 and the first display area DA1 are larger than the XY planar area of the second display portion 200 and the second display area DA2. In this case, the first display portion 100 may be a main display portion for displaying a main image, and the second display portion 200 may be a sub-display portion for displaying a sub-image.

The connecting portion 300 is disposed between adjacent display portions of the plurality of display portions 100 and 200, for example, between the first display portion 100 and the second display portion 200, and is connected to the first display portion 100 and the second display portion 200. Upper and lower ends of the connecting portion 300 may be respectively connected to the first display portion 100 and the second display portion 200, and the first display portion 100, the second display portion 200, and the connecting portion 300 may be integrally connected.

As shown in FIG. 1, in a state before the display panel 1000 is bent, the first and second data lines 171 and 172 substantially extend in a Y direction in the first display portion 100 and the second display portion 200, and the first display portion 100, the connecting portion 300, and the second display portion 200 may be sequentially arranged in the Y direction. In other words, a direction (e.g., the Y direction) in which the first and second data lines 171 and 172 are respectively disposed at the first and second display portions 100 and 200 that are connected through the connecting portion 300 mainly extend may be substantially the same as a direction (e.g., the Y direction) in which the first and second display portions 100 and 200 and the connecting portion 300 are arranged.

A boundary between the connecting portion 300 and the first display portion 100 is referred to as a first boundary BP1, and a boundary between the connecting portion 300 and the second display portion 200 is referred to as a second boundary BP2. It will be exemplarily described that the first boundary BP1 and the second boundary BP2 are included in (or as part of) the connecting portion 300. In the first and second display areas DA1 and DA2, the first boundary BP1 and the second boundary BP2 may extend in a direction (e.g., the X direction) crossing the direction (e.g., the Y direction) in which the first and second data lines 171 and 172 extend. Accordingly, in the state in which the display panel 1000 is not bent, the first display portion 100 and the connecting portion 300 are adjacent and connected to each other in the Y direction corresponding to a direction in which the first data lines 171 mainly extend, and the second display portion 200 and the connecting portion 300 may also be adjacent and connected to each other in the Y direction corresponding to a direction in which the second data lines 172 mainly extend.

A width in the X direction of the connecting portion 300 may be smaller than a width in the X direction of the first display portion 100 and a width in the X direction of the second display portion 200.

The first boundary BP1 and the second boundary BP2 may be represented by lines, but are not limited thereto, and they may be represented by elongated areas having a predetermined width around the marked lines.

At least a portion of the display panel 1000 may be deformable (e.g., intentionally deformable) to be bent during a manufacturing process of the display device or to be bent (e.g., intentionally bent or otherwise deformed) during use of a completed display device. At least a portion of the connecting portion 300 may be bent, and for example, as shown in FIG. 2 and FIG. 3, the connecting portion 300 may be bent at at least one of the first boundary BP1 and the second boundary BP2. As such, the connecting portion 300 may be referred to as a bending portion.

On the other hand, the first display portion 100 and the second display portion 200 may maintain a flat state without being substantially bent. However, since this may vary depending on a use condition of the display device, at least one among the first display portion 100 and the second display portion 200 may be bent during the manufacturing process of the display device or during the use of the completed display device. Hereinafter, the display device of which the first display portion 100 and the second display portion 200 are fixed to maintain a flat state will be mainly described.

The connecting portion 300, as shown in FIG. 2, may be bent (or may be in a bent state) at the first boundary BP1 and the second boundary BP2 (or along the boundaries), or as shown in FIG. 3, may be bent (or may be in a bent state) at one of the first boundary BP1 and the second boundary BP2. Particularly, FIG. 3 illustrates an example in which the connecting portion 300 is bent at the first boundary BP1 differently than at the secondary boundary BP2.

As shown in FIG. 2 or FIG. 3, in the state in which the display panel 1000 is bent, the first display portion 100 and the second display portion 200 may overlap each other in the Z direction. The first display portion 100 and the second display portion 200 may respectively display an image generally in a direction, which is illustrated as an arrow direction in FIGS. 2 and 3. That is, the first display portion 100 and the second display portion 200 may display images in different directions, and in some exemplary embodiments, the first display portion 100 and the second display portion 200 may display images in opposite directions, such as illustrated in at least FIG. 2.

The driving circuit portion 500 is disposed at (or on) the connecting portion 300 between the first display portion 100 and the second display portion 200. Referring to FIG. 2 and FIG. 3, the driving circuit portion 500 may be disposed on a surface of the substrate 110 on which the first and second display element portions 100P and 200P are disposed.

The driving circuit portion 500 may output at least one driving signal to the first display portion 100 and the second display portion 200 for driving the first display portion 100 and the second display portion 200. The first data lines 171 of the first display portion 100 and the second data lines 172 of the second display portion 200 may extend in the connecting portion 300 to be electrically connected with the driving circuit portion 500, and may receive data signals from the driving circuit portion 500. The driving circuit portion 500 may respectively transmit the driving signals to the first display portion 100 and the second display portion 200 to independently drive the first display portion 100 and the second display portion 200.

The driving circuit portion 500 may include a driving circuit chip bonded onto the connecting portion 300 of the display panel 1000. That is, the driving circuit portion 500 may be mounted on the display panel 1000 using a chip-on-panel (COP) technique; however, the connection type between the driving circuit portion 500 and the display panel 1000 is not limited thereto. For instance, the driving circuit portion 500 may be directly formed in (or on) the connecting portion 300 of the display panel 1000.

According to some exemplary embodiments, extended portions of the plurality of signal lines or wires (for example, the first and second data lines 171 and 172) may include only a portion disposed in one conductive layer as a whole, or a plurality of portions disposed in different conductive layers that may be connected to each other through a contact portion to form one signal line or wire. For example, in FIG. 1, a first data line 171 extending from the first display area DA1 of the first display portion 100 to the connecting portion 300 by a single line may be formed with a single conductive layer, or may be formed by electrically connecting portions disposed in different conductive layers to each other in, for instance, the middle thereof.

As shown in FIG. 2, when the display panel 1000 is bent at the first boundary BP1 and the second boundary BP2, a surface of the connecting portion 300 may be substantially perpendicular to those of the first and second display portions 100 and 200. The connecting portion 300 may extend in a direction substantially parallel to a lateral surface of the display device to form a lateral portion of the display device. The driving circuit portion 500 may be disposed on the surface of the connecting portion 300 to be disposed at the lateral portion of the display device.

As shown in FIG. 3, when the display panel 1000 is bent at only one of the first boundary BP1 and the second boundary BP2 (e.g., when it is bent at the first boundary BP1), the surface of the connecting portion 300 may be substantially parallel to the surfaces of the first and second display portions 100 and 200. A portion of the connecting portion 300 close to the first boundary BP1 may be curved. The driving circuit portion 500 may be disposed on the surface of the connecting portion 300 (e.g., on a lower surface of the substrate 110 in FIG. 3) to be directed (or facing a) downward (or upward) direction of the display device.

As shown in FIG. 2 and FIG. 3, since the first display portion 100 and the second display portion 200 display images in opposite directions to each other, a user may view different images on different surfaces of the display device. As such, when a display device has two display areas (or display surfaces) disposed on opposite sides, the display device is referred to as a dual display device. In addition, when a display device has a plurality of separate display areas (or display surfaces) capable of displaying images in different directions, the display device is referred to as a multi-display surface display device.

According to various exemplary embodiments, since the multi-display surface display device includes one display panel 1000, i.e., one substrate 110, which is bent or bendable, a structure and a manufacturing process of the display device may be simplified and manufacturing costs may be reduced. In addition, since the plurality of display portions 100 and 200 may be electrically connected to one driving circuit portion 500 on one display panel 1000 (or one substrate 110) to receive a driving signal, it is not necessary to include a plurality of circuit chips corresponding to the number of the plurality of display portions and/or an additional circuit film (for example, a flexible printed circuit film (FPC)) for applying signals. Therefore, manufacturing costs of the display device may be reduced, thereby reducing overall costs.

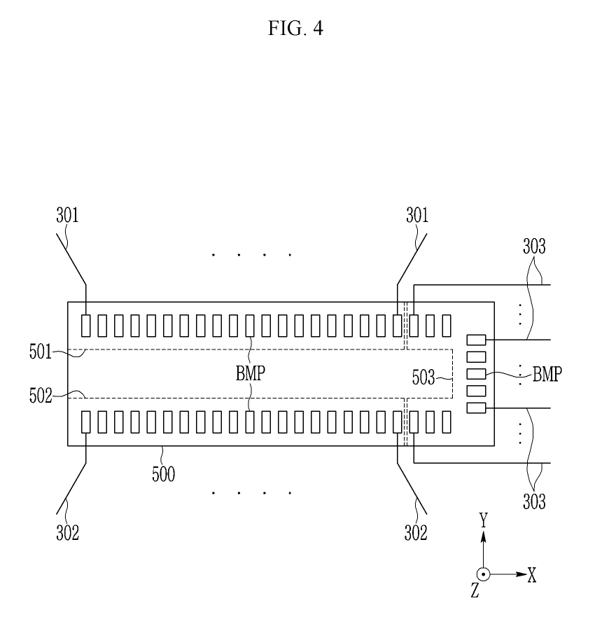

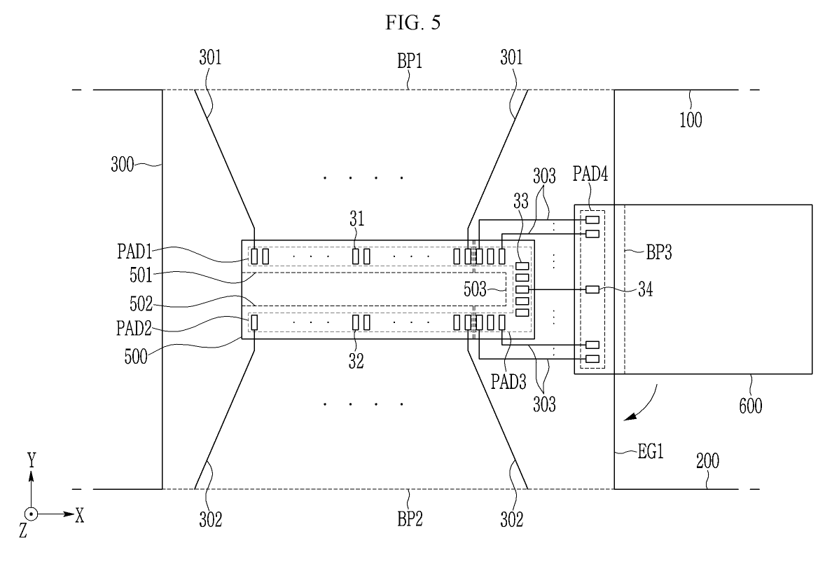

FIG. 4 illustrates disposition of bumps included in a driving circuit portion disposed at a connecting portion of a display device according to some exemplary embodiments. FIG. 5 schematically illustrates a plan layout view of a connecting portion of a display device according to some exemplary embodiments.

Referring to FIG. 4 and FIG. 5, the driving circuit portion 500 may include a first output portion 501 that is connected to first signal lines 301 connected to the first display portion 100 to be able to output a signal to the first display portion 100, a second output portion 502 that is connected to second signal lines 302 connected to the second display portion 200 to be able to output a signal to the second display portion 200, and an input portion 503 connected to third signal lines 303 that may receive a signal from the outside. Each of the first output portion 501, the second output portion 502, and the input portion 503 may include a plurality of bumps BMP.

The first output portion 501 and the second output portion 502 may be respectively disposed adjacent to different edges (or sides) of the driving circuit portion 500 in a plan view. For example, as shown in FIG. 4, the first output portion 501 may be disposed to be adjacent to an upper side of the driving circuit portion 500, and the second output portion 502 may be disposed to be adjacent to a lower side of the driving circuit portion 500 facing the upper side thereof. The input portion 503 may be disposed to be adjacent to an edge (e.g., a right or left edge) of the driving circuit portion 500 at which the first output portion 501 and the second output portion 502 are not disposed.

The first signal lines 301 may be disposed at an upper portion with respect to the driving circuit portion 500 to be connected to the first display portion 100, and the second signal lines 302 may be disposed at a lower portion with respect to the driving circuit portion 500 to be connected to the second display portion 200. In some exemplary embodiments, as the first signal lines 301 extend away from the driving circuit portion 500, an interval between the first signal lines 301 may be gradually widened. Similarly, as the second signal lines 302 extend away from the driving circuit portion 500, an interval between the second signal lines 302 may be gradually widened.

The third signal lines 303 may be mainly disposed at a left or right side of the driving circuit portion 500. Referring to FIG. 5, the third signal lines 303 may extend to a portion adjacent to an edge EG1 of the connecting portion 300 to be electrically connected to a circuit film 600, such as a flexible printed circuit film. The edge EG1 of the connecting portion 300, as shown in FIG. 5, may be a right or left edge of the connecting portion 300, which is an edge substantially extending in the Y direction between the first display portion 100 and the second display portion 200.

The first to third signal lines 301, 302, and 303 may respectively include first to third end portions 31, 32, and 33 (hereinafter, referred to as pads) for electrically connecting with the driving circuit portion 500 in the connecting portion 300, respectively. The first pads 31 of the first signal lines 301 may correspond to bumps BMP of the first output portion 501 of the driving circuit portion 500 to be substantially arranged in the X direction, and the second pads 32 of the second signal lines 302 may correspond to bumps BMP of the second output portion 502 of the driving circuit portion 500 to be substantially arranged in the X direction. The third pads 33 of the third signal lines 303 may include pads that correspond to bumps BMP of the input portion 503 of the driving circuit portion 500 to be substantially arranged in the Y direction. As seen in FIG. 4 and FIG. 5, the third pads 33 may further include pads that are adjacent to and aligned with the first and second pads 31 and 32 of the first and second signal lines 301 and 302 to be arranged in the X direction. All of the first pads 31 of the first signal lines 301 are referred to as a first pad portion PAD1, all of the second pads 32 of the second signal lines 302 are referred to as a second pad portion PAD2, and all of the third pads 33 of the third signal lines 303 are referred to as a third pad portion PAD3.

According to some exemplary embodiments, the arrangement direction of the first to third pads 31, 32, and 33 may be different from the shown direction depending on a mounted direction of the driving circuit portion 500.

The first to third pads 31, 32, and 33 of the first to third pad portions PAD1, PAD2, and PAD3 and the bumps BMP of the driving circuit portion 500 may be electrically connected to each other through conductive bonding using, for instance, an anisotropic conductive film (ACF) or the like including conductors, such as conductive balls.

Each of the third signal lines 303 may be disposed in an area adjacent to the edge EG1 of the connecting portion 300, and may include a fourth end portion (referred to as a pad) 34 for electrically connecting with the circuit film 600. The fourth pads 34 of the third signal lines 303 may be substantially arranged in the Y direction along the edge EG1 of the connecting portion 300. All of the fourth pads 34 of the third signal lines 303 are referred to as a fourth pad portion PAD4.

Referring to FIG. 5, the circuit film 600 may be electrically connected to the fourth pads 34 of the fourth pad portion PAD4 to input a signal to the driving circuit portion 500 through the third signal lines 303. The connecting portion 300 and the circuit film 600 may be substantially arranged in the X direction in a plan view, and may partially overlap each other. The circuit film 600 may be bent toward a rear (or underside) of the connecting portion 300 near a third bending line BP3 adjacent to the edge EG1 of the connecting portion 300 as indicated by an arrow in FIG. 5. That is, the circuit film 600 may be bent and overlapped with the connecting portion 300 in the Z direction.

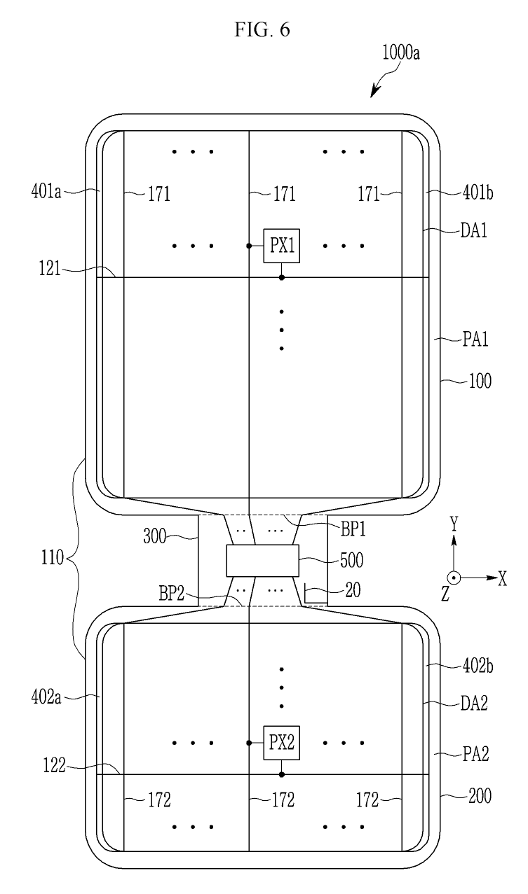

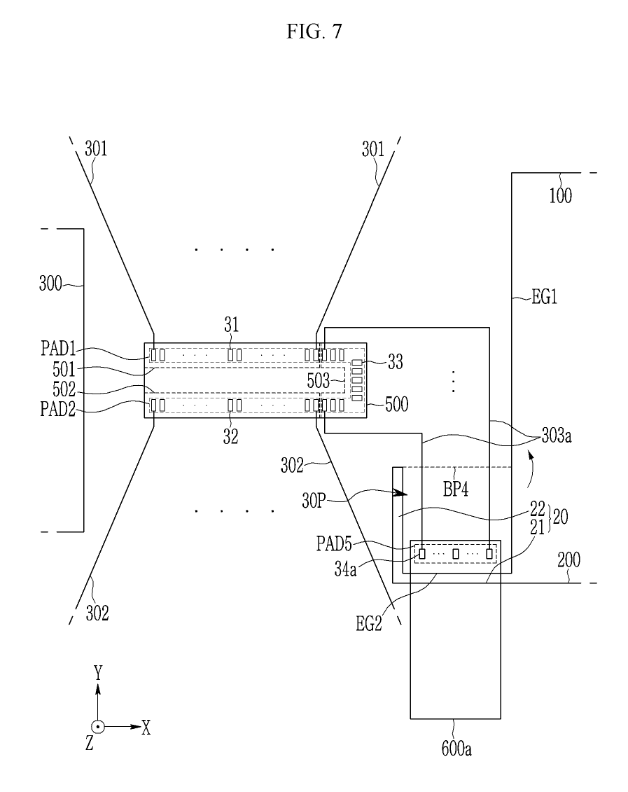

A display device according to some exemplary embodiments will now be described with reference to FIGS. 6 and 7, as well as FIGS. 1 to 5.

FIG. 6 illustrates a plan layout view of a display panel of a display device in an unbent state according to some exemplary embodiments. FIG. 7 schematically illustrates a plan layout view of a connecting portion of a display device according to some exemplary embodiments. To avoid obscuring exemplary embodiments, duplicative descriptions will be primarily omitted.

Referring to FIG. 6 and FIG. 7, a display panel 1000a of a display device according to some exemplary embodiments is similar to the display panel 1000, but the connecting portion 300 may be provided with a cutout 20, and a structure of the connecting portion 300 may be partially different. Differences from the exemplary embodiments described above will be mainly described.

The cutout 20, which is a portion in which the connection portion 300 is partly cut off, may include a horizontal portion 21 substantially extending in the X direction from the edge EG1 of the connecting portion 300 and a vertical portion 22 that is connected to the horizontal portion 21 and extends in the Y direction to the inside of the connecting portion 300. A lower edge EG2 of the connecting portion 300 may be formed by the horizontal portion 21 of the cutout 20. The lower edge EG2 of the connecting portion 300 may face the second display portion 200 with the horizontal portion 21 of the cutout 20 therebetween.

Third signal lines 303a electrically connected to the input portion 503 of the driving circuit portion 500 are mostly the same as the third signal lines 303 described above, and may include a portion that is bent near the edge EG1 of the connecting portion 300 and then extend along the edge EG1. Each of the third signal lines 303a may include a fourth end portion (referred to as a pad) 34a that extends to be substantially parallel to the vertical portion 22 of the cutout 20 and is disposed at a portion adjacent to the horizontal portion 21 of the cutout 20. The fourth pads 34a may be substantially arranged in the X direction to be parallel to the lower edge EG2 of the connecting portion 300. All of the fourth pads 34a of the third signal lines 303a are referred to as a fifth pad portion PAD5.

Referring to FIG. 7, the second signal lines 302 connected to the second display portion 200 may face the third signal lines 303a with the vertical portion 22 of the cutout 20 therebetween. That is, a portion (e.g., the vertical portion 22) of the cutout 20 may be disposed between a portion at which the second signal lines 302 are disposed and a portion at which the third signal lines 303a are disposed.

A circuit film 600a may be electrically connected to the fourth pads 34a of the fifth pad portion PAD5 to input a signal to the driving circuit portion 500 through the third signal lines 303a. A portion 30P of the connecting portion 300 and the circuit film 600a that are divided by the cutout 20 may be substantially arranged in the Y direction in a plan view, and the portion 30P and the circuit film 600a may partially overlap each other.

A width in the X direction of the circuit film 600a may be similar to or smaller than a width in the X direction of the portion 30P of the connecting portion 300. A top end of the portion 30P of the connecting portion 300 divided by the cutout 20 may be defined as a fourth boundary BP4 passing an upper end of the vertical portion 22 of the cutout 20.

Both the portion 30P of the connecting portion 300 and the circuit film 600a connected thereto may be bent toward a rear of the connecting portion 300 at the fourth boundary BP4 by the cutout 20, as indicated by an arrow in FIG. 7. That is, the portion 30P of the connecting portion 300 may partially overlap the remaining portion of the connecting portion 300 in the Z direction.

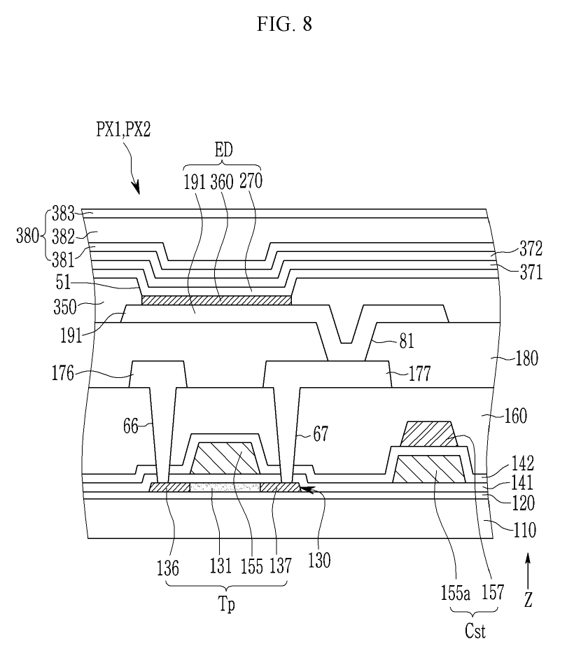

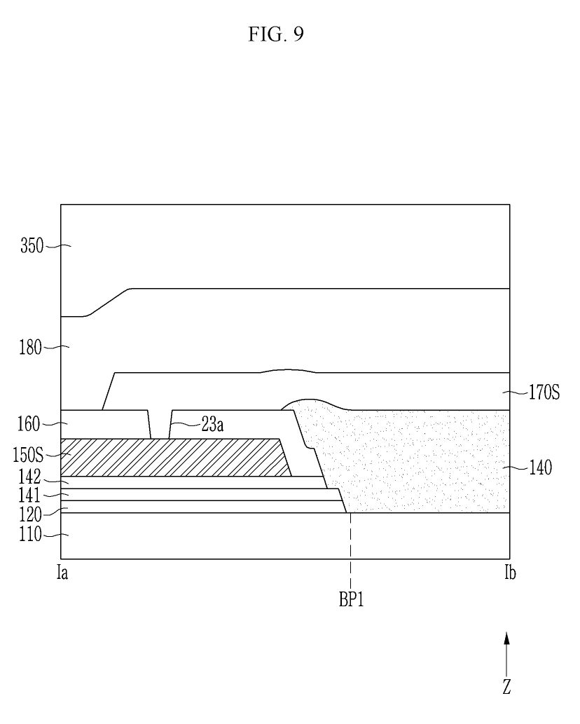

Hereinafter, cross-sectional structures of the display panels 1000 and 1000a included in the display device according to some exemplary embodiments will be described with reference to FIG. 8 and FIG. 9 together with the above-described drawings.

FIG. 8 illustrates a cross-sectional view of a pixel of a display panel according to some exemplary embodiments. FIG. 9 illustrates a cross-sectional view of the display panel of FIG. 1 taken along sectional line Ia-Ib according to some exemplary embodiments. That is, FIG. 8 illustrates a cross-sectional structure of the first pixel PX1 or the second PX2 disposed in the first display area DA1 or the second display area DA2 of the first display portion 100 or the second display portion 200. FIG. 9 illustrates a cross-sectional structure around the first boundary BP1 of the display panel 1000 shown in FIG. 1 as an example. The structure in FIG. 9 may be similarly applied to the second boundary BP2 in addition to the first boundary BP1.

Referring to FIG. 8, the display panel 1000 or 1000a according to some exemplary embodiments may include at least one transistor Tp, at least one capacitor Cst, and at least one light emitting diode ED, which are disposed at (or as part of) the pixel PX1 or PX2.

A barrier layer 120 formed with a plurality of layers or a single layer may be disposed on the substrate 110, and a plurality of active patterns 130 may be disposed on the barrier layer 120. The active pattern 130 may be referred to as an active layer, but it is mainly referred to as an active pattern because it is patterned. The plurality of the active patterns 130 may include source areas 136, drain areas 137, and channel areas 131 disposed between the source areas 136 and the drain areas 137. The active pattern 130 may contain a semiconductor material, such as amorphous silicon, polysilicon, or an oxide semiconductor. A portion of the active pattern 130 may maintain the same semiconductor properties as that of the channel area 131, and the other portion may have the same conductivity as those of the source area 136 and the drain area 137.

A first insulating layer 141 may be disposed on the active pattern 130, and a first conductive layer including a gate electrode 155 and a first electrode 155a may be disposed on the first insulating layer 141. The active pattern 130 and the gate electrode 155 overlapping the active pattern 130 may form a portion of transistor Tp. The transistor Tp may include the channel area 131, the source area 136, the drain area 137, and the gate electrode 155 overlapping the channel area 131.

A second insulating layer 142 may be disposed on the first conductive layer and the first insulating layer 141, and a second conductive layer including a second electrode 157 may be disposed on the second insulating layer 142. The first electrode 155a and the second electrode 157 overlapping each other with the second insulating layer 142 therebetween may form the capacitor Cst. The first electrode 155a may be connected to a gate electrode of another transistor (not shown) included in the first and/or second pixels PX1 and PX2, and in this case, the capacitor Cst may function to maintain a voltage of the gate electrode connected to the first electrode 155a. The second electrode 157 may receive a constant voltage, such as a driving voltage. A third insulating layer 160 may be disposed on the second conductive layer and the second insulating layer 142.

A least one of the barrier layer 120, the first insulating layer 141, the second insulating layer 142, and the third insulating layer 160 may include an inorganic insulating material and/or an organic insulating material, such as a silicon nitride (SiNx), a silicon oxide (SiOx), a silicon oxynitride (SiON), and/or the like. Some or all of the first insulating layer 141, the second insulating layer 142, and the third insulating layer 160 may include a plurality of contact holes, such as contact holes 66 and 67.

A third conductive layer may be disposed on the third insulating layer 160. The third conductive layer may include a plurality of connecting electrodes 176 and 177, at least some of the first and second data lines 171 and 172, and the like. The connecting electrode 176 may be electrically connected to the source area 136 of the transistor Tp through the contact hole 66, and the connecting electrode 177 may be electrically connected to the drain area 137 of the transistor Tp through the contact hole 67. The connecting electrode 176 may be omitted.

At least one among the first conductive layer, the second conductive layer, and the third conductive layer may include a conductive material, such as a metal, e.g., copper (Cu), silver (Ag), aluminum (Al), molybdenum (Mo), titanium (Ti), and tantalum (Ta), and/or an alloy of at least two thereof.

A passivation layer 180 may be disposed on the third conductive layer and the third insulating layer 160. The passivation layer 180 may be provided with a contact hole 81 disposed on, and, thereby, exposing a portion of the connecting electrode 177. The passivation layer 180 may include an inorganic insulating material and/or an organic insulating material, such as a polyacrylic resin and a polyimide-based resin, and an upper surface of the passivation layer 180 may be substantially flat.

A fourth conductive layer including a pixel electrode 191 may be disposed on the passivation layer 180. The pixel electrode 191 may be disposed at respective first and second pixels PX1 and PX2, and may be connected to the connecting electrode 177 through the contact hole 81 to receive a data voltage. The fourth conductive layer may include a transflective conductive material or a reflective conductive material, but is not limited thereto.

A pixel defining layer 350 may be disposed on the passivation layer 180. The pixel defining layer 350 may be provided with an opening (or a hole) 51, which is disposed on the pixel electrode 191. The pixel defining layer 350 is removed at the opening 51, and thus, the pixel electrode 191 may be exposed without being covered by the pixel defining layer 350. In some exemplary embodiments, such as shown in FIG. 8, the pixel defining layer 350 may partially cover the pixel electrode 191, e.g., cover edge portions of the pixel electrode 191. The pixel defining layer 350 may include a photosensitive organic material, such as a polyacryl-based resin, a polyimide-based resin, and/or the like.

An emission layer 360 is disposed on the pixel electrode 191. The emission layer 360 may include a portion disposed in the opening 51 of the pixel defining layer 350. The emission layer 360 may include an organic emission material or inorganic emission material.

A common electrode 270 is disposed on the emission layer 360. In respective display areas DA1 and DA2, the common electrode 270 may be formed on the pixel defining layer 350 to be continuously formed over the plurality of first and second pixels PX1 and PX2. The common electrode 270 may include a conductive transparent material, but is not limited thereto. Accordingly, the pixel electrode 191, the emission layer 360, and the common electrode 270 of each of the first and second pixels PX1 and PX2 may form a light emitting diode ED.

A capping layer 371 and/or a functional layer 372 may be disposed on the common electrode 270. The capping layer 371 may serve to increase light efficiency through adjustment of a refractive index, and the functional layer 372 may prevent damage to layers disposed below it and increase the light efficiency. The functional layer 372 and the capping layer 371 may not be disposed in at least part of the peripheral areas PA1 and PA2.

An encapsulation layer 380 may be disposed on the functional layer 372. The encapsulation layer 380 may seal the light emitting diode ED to prevent (or at least reduce) moisture or oxygen from penetrating from the outside. The encapsulation layer 380 may include at least one inorganic layer 381 and 383 including an inorganic material, and at least one organic layer 382 including an organic material. The inorganic layers 381 and 383 and the organic layer 382 may be alternately stacked. Although the encapsulation layer 380 is shown including three layers, exemplary embodiments are not limited thereto.

Referring to FIG. 9 together with the above-described drawings, at least one among the barrier layer 120, the first insulating layer 141, the second insulating layer 142, and the third insulating layer 160 may be eliminated in an area corresponding to the connecting portion 300 with respect to the first boundary BP1 and/or the second boundary BP2 of the connecting portion 300 at which the display panel 1000 or 1000a is bent.

Before portions disposed at different conductive layers included in signal lines, such as the first and second data lines 171 and 172, cross the first boundary BP1 or the second boundary BP2, they may be electrically connected to each other through a contact portion.

As shown in FIG. 9, at least some of the signal lines crossing the first boundary BP1 or the second boundary BP2 may include a wire 150S disposed at the second conductive layer described above, and a wire 170S disposed at the third conductive layer. The wire 170S may be disposed at the connecting portion 300, and the wire 150S may be disposed at the first display portion 100 or the second display portion 200.

The wire 170S may be electrically connected to the wire 150S disposed at a different layer from the wire 170S to transmit the same signal as that of the wire 150S through a contact portion 23a (which may be the contact hole of the third insulating layer 160) above the first boundary BP1 or below the second boundary BP2.

A fourth insulating layer 140 may be disposed at (or on) the connecting portion 300. The fourth insulating layer 140, which is formed after the third insulating layer 160, may be disposed below the wire 170S, which is part of the third conductive layer. The fourth insulating layer 140 may cover the substrate 110 of the connecting portion 300 to protect the connecting portion 300 in which the barrier layer 120, the first insulating layer 141, the second insulating layer 142, and the third insulating layer 160 are eliminated. The fourth insulating layer 140 may include an organic insulating material, such as a polyimide, an acryl-based polymer, a siloxane-based polymer, and/or the like. In the connecting portion 300, the wire 170S as the third conductive layer, the passivation layer 180, and the pixel defining layer 350 may be sequentially stacked on the fourth insulating layer 140.

Although certain exemplary embodiments and implementations have been described herein, other embodiments and modifications will be apparent from this description. Accordingly, the inventive concepts are not limited to such embodiments, but rather to the broader scope of the accompanying claims and various obvious modifications and equivalent arrangements as would be apparent to one of ordinary skill in the art.

What is claimed is:

1. A display device comprising:
a display panel comprising a first display portion, a second display portion, and a connecting portion; and
a driving circuit portion disposed on the connecting portion,
wherein:
the connecting portion is connected to the first display portion and the second display portion, and is disposed between the first display portion and the second display portion;
the first display portion comprises first pixels and first data lines electrically connected to the first pixels;
the second display portion comprises second pixels and second data lines electrically connected to the second pixels; and
the driving circuit portion is electrically connected to the first data lines and the second data lines.

2. The display device of claim 1, wherein the first display portion and the second display portion are configured to respectively display images in different directions from each other.

3. The display device of claim 2, wherein:
the display panel comprises a flexible substrate;
the first display portion, the second display portion, and the connecting portion are disposed on the flexible substrate; and
the display panel is bent or bendable at at least a portion among at least one of a first boundary between the connecting portion and the first display portion, a second boundary between the connecting portion and the second display portion, and the connecting portion.

4. The display device of claim 3, further comprising:
at least one insulating layer disposed on the flexible substrate,
wherein the at least one insulating layer comprises a portion disposed on the first display portion and the second display portion, the at least one insulating layer being removed at the s connecting portion.

5. The display device of claim 1, wherein:
the driving circuit portion comprises:
a first output portion electrically connected to the first data lines;
a second output portion electrically connected to the second data lines; and
an input portion; and
the first output portion and the second output portion are disposed respectively adjacent to two edges of the driving circuit portion, the two edges opposing each other.

6. The display device of claim 5, wherein:
the connecting portion comprises signal lines electrically connected to the input portion; and
the display device further comprises a circuit film electrically connected to the signal lines.

7. The display device of claim 6, wherein the circuit film is bent to overlap the connecting portion.

8. The display device of claim 7, wherein:
the connecting portion comprises a first edge extending from the first display portion to the second display portion; and
the circuit film is bent at a portion adjacent to the first edge.

9. The display device of claim 6, wherein:
the connecting portion comprises a cutout, the cutout comprising a portion adjacent to an end portion of the signal lines;
the circuit film is connected to a first portion of the connecting portion that is divided by the cutout; and
the first portion is bent to overlap a remaining portion of the connecting portion.

10. The display device of claim 9, wherein the cutout comprises a second portion disposed between a portion at which the second data lines are disposed and a portion at which the signal lines are disposed.

11. The display device of claim 10, wherein a direction in which the connecting portion and the first display portion or the second display portion are arranged is the same as a direction in which the first portion and the circuit film are arranged.

12. The display device of claim 1, wherein a width in a first direction of the connecting portion is smaller than a width in the first direction of at least one among the first display portion and the second display portion.

13. A display device comprising:
a display panel comprising a first display portion, a second display portion, and a connecting portion;
a driving circuit portion disposed on the connecting portion;
a first signal line comprising a portion disposed on the first display portion; and
a second signal line comprising a portion disposed on the second display portion,
wherein:
the connecting portion is connected to the first display portion and the second display portion, and is disposed between the first display portion and the second display portion;
the driving circuit portion comprises a first output portion connected to the first signal line, and a second output portion connected to the second signal line; and
the first output portion and the second output portion are disposed respectively adjacent to two edges of the driving circuit portion, the two edges opposing each other.

14. The display device of claim 13, wherein the first display portion and the second display portion respectively display images in different directions from each other.

15. The display device of claim 14, wherein:
the display panel comprises a flexible substrate;
the first display portion, the second display portion, and the connecting portion are disposed on the flexible substrate; and
the display panel is bent or bendable at at least a portion among at least one of a first boundary between the connecting portion and the first display portion, a second boundary between the connecting portion and the second display portion, and the connecting portion.

16. The display device of claim 13, wherein:
the driving circuit portion comprises an input portion separate from the first output portion and the second output portion;
the connecting portion comprises a third signal line electrically connected to the input portion;
the display device further comprises a circuit film electrically connected to the third signal line; and
the circuit film comprises a portion overlapping the connecting portion.

17. The display device of claim 16, wherein:
the connecting portion comprises a cutout, the cutout comprising a portion adjacent to an end portion of the third signal line;
the circuit film is connected to a first portion of the connecting portion that is divided by the cutout; and
the first portion is bent to overlap a remaining portion of the connecting portion.

18. A display device comprising:
a display panel comprising a first display portion, a second display portion, and a connecting portion;
a driving circuit portion disposed on the connecting portion;
a first data line comprising a portion disposed on the first display portion; and
a second data line comprising a portion disposed on the second display portion,
wherein:
the connecting portion is connected to the first display portion and the second display portion, and is disposed between the first display portion and the second display portion;
the display panel is bent or bendable at at least a portion among at least one of a first boundary between the first display portion and the connecting portion, a second boundary between the connecting portion and the second display portion, and the connecting portion;
the first data line substantially extends in a first direction in a display area of the first display portion; and
at least one among the first boundary and the second boundary extends in a second direction different from the first direction.

19. The display device of claim 18, wherein the driving circuit portion is electrically connected to the first data line and the second data line.

20. The display device of claim 19, wherein the first display portion and the second display portion respectively display images in different directions from each other.
